(19) United States
(12) Patent Application Publication
(10) Pub. No.: US 2006/0244720 A1
(43) Pub. Date: Nov. 2, 2006

(54) Collapsible projection assembly

(76) Inventor: James L. Tracy, Coral Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/118,458

(22) Filed: Apr. 29, 2005

(51) Int. Cl. G09G 5/00

(52) U.S. Cl. 345/156

(57) ABSTRACT

The invention concerns a collapsible projection assembly (112) and a method (600) for operating same. The collapsible projection assembly can include a rotatable arm (116) having at least one pivot point (118), a projector (120) that can project an image (122) onto a surface (114), a first sensor (124) that can detect the location of an input device (128) in relation to the image and a second sensor (126) that can detect when the input device pierces a plane (130) above the image. The rotatable arm can be movable from a non-operational position to an operational position such that a predetermined spatial relationship between the projector, the first sensor and the second senor can be at least substantially maintained when the rotatable arm reaches the operational position.

### BACKGROUND OF THE INVENTION

1. Field of the Invention

This invention relates in general to projection systems and more particularly, projection systems that generate virtual input/output interfaces.

2. Description of the Related Art

The use of portable electronic devices, like cellular telephones and personal digital assistants, has exploded in recent years. In particular, many companies are developing various electronic devices to enable people to generate and process all types of data. For example, Canesta, Inc. of Sunnyvale, Calif. has created a virtual keyboard device that receives input from a user and transfers the input to a separate computing device. The keyboard device includes a projector that beams onto a flat surface a pattern of visible light that resembles a QWERTY keyboard. The keyboard device also includes a sensor and an infrared (IR) unit, which projects an IR beam slightly above the flat surface. The sensor detects the position of a user's finger in relation to X and Y axes of the virtual keyboard, while the IR unit detects when a user's finger breaks the IR beam. Thus, the sensor and the IR unit work in tandem to determine which of the keys of the virtual keyboard the user has been activated.

To operate correctly, the spatial relationship between the projector, the sensor and the IR unit must be properly maintained. In particular, the distances between these components and the angles at which they are positioned in relation to a surface on which the keyboard device is positioned must be in accordance with stringent, predetermined measurements. If they are not, the virtual keyboard device may have a difficult time interpreting the input from the user. To comply with these requirements, the projector must be positioned relatively high above the sensor and the IR unit. As a result, the virtual keyboard device is quite bulky, susceptible to damage and not very aesthetically pleasing.

### SUMMARY OF THE INVENTION

The present invention concerns a collapsible projection assembly. In one arrangement, the collapsible projection assembly can include a rotatable arm having at least one pivot point, a projector that can project an image onto a surface, a first sensor that can detect the location of an input device in relation to the image and a second sensor that can detect when the input device pierces a plane above the image. The rotatable arm can be movable from a non-operational position to an operational position such that a predetermined spatial relationship between the projector, the first sensor and the second senor can be at least substantially maintained when the rotatable arm reaches the operational position.

The collapsible projection assembly can further include a locking mechanism. The locking mechanism can lock the rotatable arm in the operational position and can permit the rotatable arm to move to the non-operational position. In another arrangement, the collapsible projection assembly can also have an activation mechanism. The activation mechanism can activate the projector, the first sensor and/or the second sensor when the rotatable arm is moved to the operational position.

In one embodiment, the projector, the first sensor and the second sensor can be incorporated in the rotatable arm. In addition, the collapsible projection assembly can include a base in which the pivot point can pivotably attach the rotatable arm to the base. In this example, the second sensor can be incorporated in the base, and the first sensor and the projector can be incorporated in the rotatable arm. Also in this example, the pivot point can be located above the second sensor and below the first sensor and the projector.

In yet another embodiment, the rotatable arm can have a protrusion, and the locking mechanism can include a channel. The protrusion can slide along the channel as the rotatable arm is moved from the non-operational position to the operational position. The collapsible projection assembly can also include a flexible circuit that can electrically couple the projector, the first sensor and the second sensor. As another example, the collapsible projection assembly can be pivotably coupled to a host device through at least one of the pivot points, and the host device can provide input to and can receive output from the projector, the first sensor or the second sensor. As an example, the image can be an image of a QWERTY keyboard, a piano keyboard or a gaming pattern.

As another example, the projector, the first sensor and the second sensor each can have a center. The predetermined spatial relationship can include the center of the first sensor being approximately 0.5 millimeters to approximately 2 millimeters in front of the center of the projector and the center of the second sensor being approximately 4 millimeters to approximately 7 millimeters in front of the center of the projector. In addition, the predetermined spatial relationship can include the center of the projector being approximately 70 millimeters to approximately 90 millimeters from the surface, the center of the first sensor being approximately 25 millimeters to approximately 35 millimeters from the surface and the center of the second sensor being approximately 3 millimeters to approximately 6 millimeters from the surface.

The present invention also concerns a method of operating a collapsible projection assembly. The collapsible projection assembly can have a rotatable arm containing a pivot point and can have a projector, a first sensor and a second sensor. The method can include the steps of moving the rotatable arm from a non-operational position to an operational position such that a predetermined spatial relationship between the projector, the first sensor and the second senor is at least substantially maintained when the rotatable arm reaches the operational position and projecting an image onto a surface from the projector. The method can also include the step of activating the projector, the first sensor and/or the second sensor when the rotatable arm is moved to the operational position. The collapsible projection assembly can further include a locking mechanism, and the method can also include locking the rotatable arm in the operational position with the locking mechanism.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a perspective view of a collapsible projection assembly in an operational position in accordance with an embodiment of the inventive arrangements;

FIG. 2 illustrates a perspective view of a collapsible projection assembly in a non-operational position in accordance with an embodiment of the inventive arrangements;

FIG. 3 illustrates a perspective view of another collapsible projection assembly in an operational position in accordance with an embodiment of the inventive arrangements;

FIG. 4 illustrates an example of a predetermined spatial relationship between certain components of a collapsible projection assembly in accordance with an embodiment of the inventive arrangements;

FIG. 5 illustrates a block diagram representing the electrical connections of a collapsible projection assembly in accordance with an embodiment of the inventive arrangements; and

FIG. 6 illustrates a flowchart demonstrating the operation of a collapsible projection assembly in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The invention concerns a collapsible projection assembly and a method of operating same. The projection assembly can include a rotatable arm having at least one pivot point, a projector that can project an image onto a surface, a first sensor that can detect the location of an input device in relation to the image and a second sensor that can detect when the input device pierces a plane above the image. In one arrangement, the rotatable arm can be movable from a non-operational position to an operational position such that a predetermined spatial relationship between the projector, the first sensor and the second senor can be at least substantially maintained when the rotatable arm reaches the operational position. As a result, the invention allows for the operation of a virtual keyboard in a compact, collapsible package.

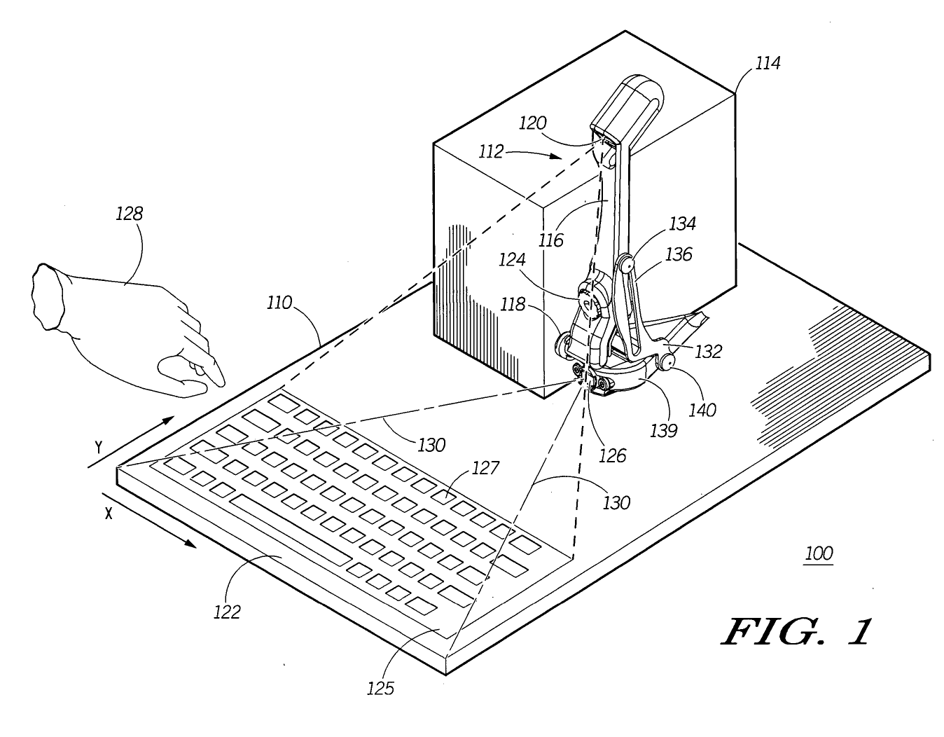

Referring to FIG. 1, a system 100 for projecting an image onto a surface 110 is shown. In one arrangement, the system 100 can include a collapsible projection assembly 112 and a host device 114. For convenience, the collapsible projection assembly 112 may be referred to as a projection assembly 112 or merely as an assembly 112. The host device 114 can be any device suitable for supporting the collapsible projection assembly 112, such as a charger or docking station. In addition, the host device 114 may also include a portable electronic device capable of processing data, such as a mobile communications device. In one arrangement, the projection assembly 112 can include a rotatable arm 116, which can have a pivot point 118. The pivot point 118 can pivotably couple the rotatable arm 116 to the host device 114.

Although only one pivot point is shown in FIG. 1, it is understood that the assembly 112 may include any suitable number of pivot points, each of which may or may not pivotably couple the rotatable arm 116 to the host device 114. For example, the rotatable arm 116 may have two or more segments, each of which can be pivotably coupled to one another through such pivot points. No matter how many pivot points are employed in the assembly 112, the predetermined spatial relationship mentioned above can be maintained.

The assembly 112 can also include a projector 120 that can project an image 122 onto the surface 110. The projector 120 can project any suitable image 122 onto the surface 110. As an example, the image 122 can be a QWERTY keyboard 125 having a plurality of keys 127, which is shown in FIG. 1. It is important to note, however, that the invention is not limited to this particular example, as the image can also be a piano keyboard, a gaming pattern, such as a checkers or chess board, or any other suitable pattern. The operation of the projector 120 is well known, and a detailed description of such is not necessary here.

The assembly 112 can also include a first sensor 124 and a second sensor 126. The first sensor 124, as is known in the art, can detect the location of an input device 128 in relation to the image 122. In particular, the first sensor 124 can determine where the input device 128 is positioned along X and Y axes of the image 122. As a result, in this example, the first sensor 124 can determine above which key 127 of the QWERTY keyboard 125 the input device 128 is positioned.

As is also known in the art, the second sensor 126 can project a plane 130 that can be positioned above the image 122. As an example, the second sensor 126 can be an IR unit, and the plane 130 can be a plane of non-visible light. The second sensor 126 can detect when the input device 128 pierces the plane 130. The piercing motion can indicate, for example, when a user intends to activate a key 127 of the keyboard 125, as is known in the art. The input device 128 can be any suitable component capable of activating the keys 127 or any other portion of the image 122. Examples can include a human finger or a stylus.

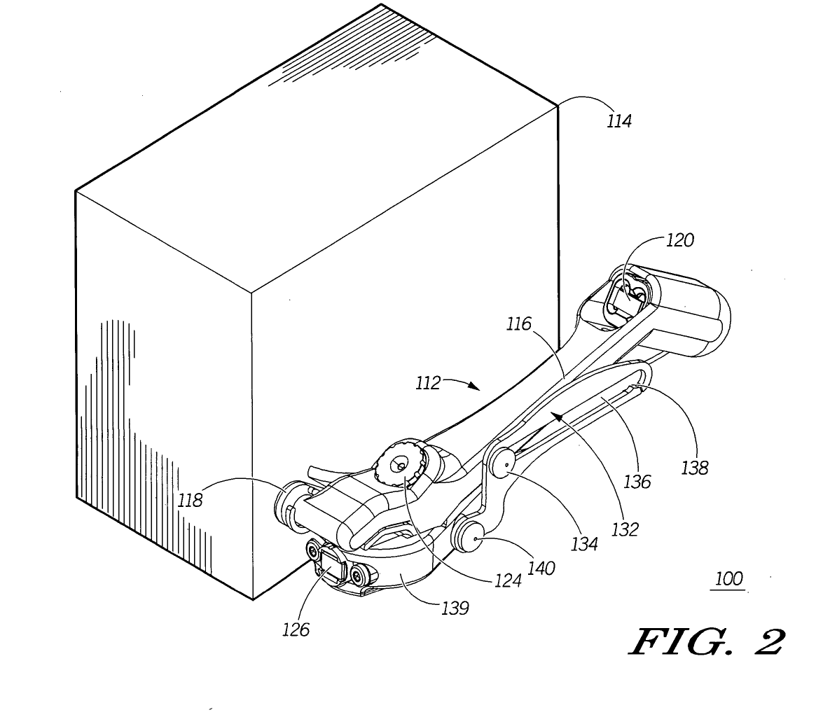

The projection assembly 112 may also include a locking mechanism 132. The locking mechanism 132 can lock the rotatable arm 116 in an operational position, an example of which is shown in FIG. 1. The locking mechanism 132 may also permit the rotatable arm to move to a non-operational position, an example of which is shown in FIG. 2. For example, the rotatable arm 116 can include a protrusion 134 that fits inside a channel 136 of the locking mechanism 132. The channel 136 may include a snap fit area 138 (see FIG. 2) that can be designed to capture the protrusion 134 of the rotatable arm 116.

In one arrangement, the projection assembly 112 can further include a base 139, which can be attached to the host device 114. The locking mechanism 132 may also contain a pivot point 140, which can pivotably couple the locking mechanism 132 to the base 139. As the rotatable arm 116 is moved from a non-operational position (see FIG. 2) to an operational position (see FIG. 1), the locking mechanism 132 can pivot at the pivot point 140, and the protrusion 134 can slide along the channel 136 until it snaps into the snap fit area 138.

It is understood that the invention is in no way limited to this particular locking mechanism 132, as any locking mechanism that can lock the rotatable arm 116 in an operational position and help move it to a non-operational position is within contemplation of the inventive arrangements. For purposes of the invention, an operational position can be any position in which the projector 120 can project a suitable image 122, the first sensor 124 can suitably detect the location of the input device in relation to the image 122 and the third sensor 126 can suitably detect when an input device 128 pierces the plane 130 above the image 122. A non-operational position can be any position in which the projector 120, the first sensor 124 or the third sensor 126 is unable to suitably perform their respective functions and in which the overall profile of the assembly 112 is substantially reduced.

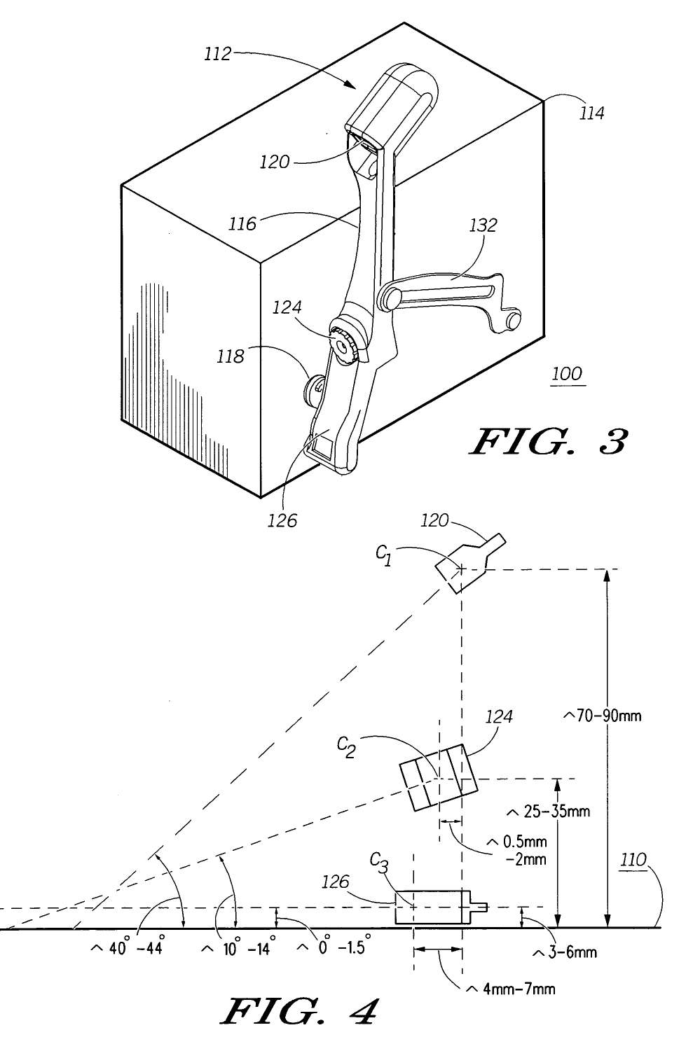

In one arrangement, the projector 120 and the first sensor 124 can be incorporated in the rotatable arm 116, which is shown in FIGS. 1 and 2. In addition, the second sensor 126 can be incorporated in the base 139. In this embodiment, the pivot point 118 can be located above the second sensor 126 and below the first sensor 124 and the projector 120. Referring to FIG. 3, another example of the projection assembly 112 is shown. Here, the projector 120, the first sensor 124 and the second sensor 126 can be incorporated in the rotatable arm 116. Of course, the invention is not limited to these particular examples, as there are other suitable configurations in which the projector 120, the first sensor 124 and the second sensor 126 are strategically positioned in relation to the rotatable arm 116.

A predetermined spatial relationship can exist between the projector 120, the first sensor 124 and the second sensor 126. For example, referring to FIG. 4, the projector 120 can have a center C₁, which can be the back of a lens (not shown) built into the projector 120. Moreover, the first sensor 124 can have a center C₂, which can be a focal point (not shown) of the first sensor 124. The second sensor 126 can have a center C₃. The center C₃ can be the back of a lens (not shown) of the second sensor 126. As part of the predetermined spatial relationship, these centers, C₁, C₂ and C₃, can be a predetermined distance away from the surface 110 on which the host device 114 sits when the rotatable arm 116 is in the operational position. For convenience, the remaining portions of the assembly 112 are not shown.

As an example, the center C₁ of the projector 120 can be approximately 70 millimeters (mm) to approximately 90 mm from the surface 110 on which the host device 114 is resting. As another example, the center C₂ of the first sensor 124 can be approximately 25 mm to approximately 35 mm from the surface 110. In yet another example, the center C₃ of the second sensor 126 can be approximately 3 mm to approximately 6 mm from the surface 110.

As another part of the predetermined spatial relationship, the centers C₁, C₂ and C₃ can also be a predetermined horizontal distance away from one another when the rotatable arm 116 is in the operational position. For example, the center C₂ of the first sensor 124 can be approximately 0.5 mm to approximately 2 mm in front of the center C₁ of the projector 120. As another example, the center C₃ of the second sensor 126 can be approximately 4 mm to approximately 7 mm in front of the center C₁ of the projector 120. It is understood, however, that the invention is in no way limited to the examples listed above, as the predetermined spatial relationship can include other suitable measurements. In addition, the predetermined spatial relationship can include proportional increments of each of the ranges listed above, such as multiplying each range by the same predetermined number.

In yet another part of the predetermined spatial relationship, the projector 120, the first sensor 124 and the second sensor 126 can be positioned at predetermined angles with respect to the surface 114. For example, the projector 120 can be positioned at an angle from approximately 40 degrees to approximately 44 degrees with respect to the surface 114. As another example, the first sensor 124 can be positioned at an angle from approximately 10 degrees to approximately 14 degrees with respect to the surface 114. Finally, the second sensor 126 can be positioned at angle from approximately 0 degrees to approximately 1.5 degrees with respect to the surface 114. Of course, the above measurements are merely examples of the various configurations in which these components can be positioned and are not meant to limit the invention in any way. Also, similar to the distances listed above, the predetermined spatial relationship can include proportional increments of each of the ranges of the angles listed above, such as multiplying each range by the same predetermined number.

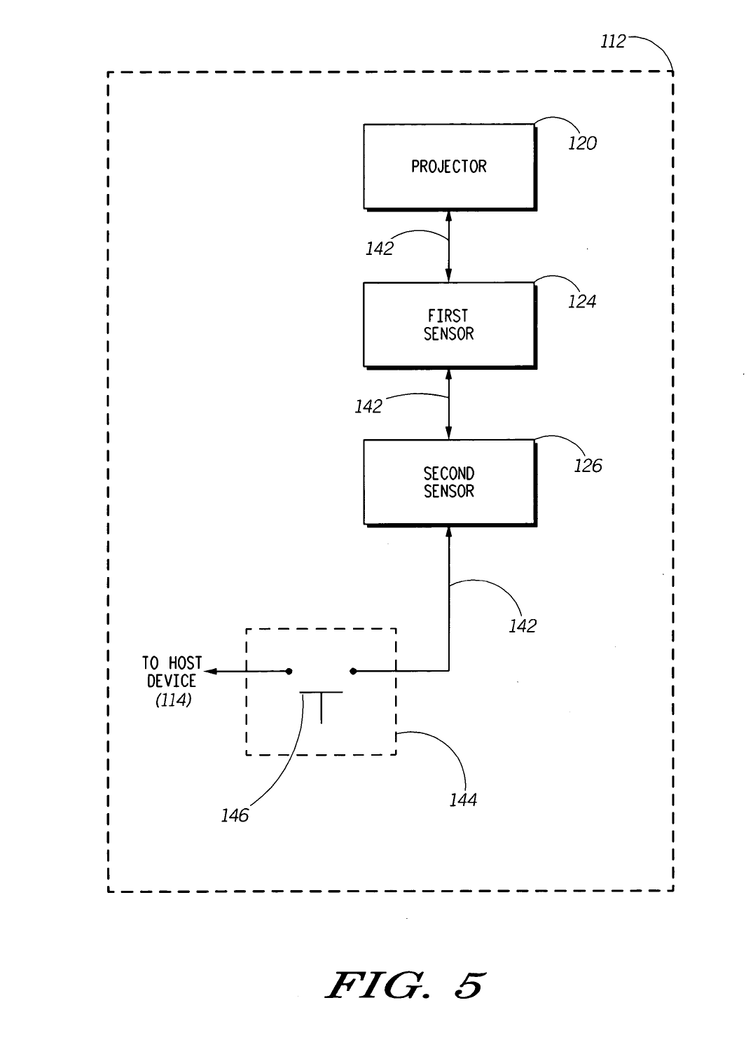

Referring to FIG. 5, a block diagram representing the electrical connections of the projection assembly 112 is shown. As an example, a flexible circuit 142 can electrically coupled the projector 120, the first sensor 124 and the second sensor 126. In addition, the flexible circuit 142 can electrically coupled each of these components to the host device 114. In another arrangement, the assembly 112 can include an activation mechanism 144, which can control the connection between the host device 114 and the projector 120, the first sensor 124 and the second sensor 126.

As an example, the activation mechanism 144 can be a switch 146, whose setting is determined by the positioning of the rotatable arm 116. For example, when the rotatable arm 116 is in the non-operational position (see FIG. 2), the switch 146 can be in an open position, which can disable the operation of the projector 120, the first sensor 124 or the second sensor 126. Conversely, when the switch 146 is in the operational position (see FIG. 1), the switch 146 can be in a closed position, which can activate the operation of one or more of these components. As another example and as those of skill in the art will appreciate, if desired, the projection assembly 112 can be designed to wirelessly transmit and received signals from the host device 114. Through the above-described configurations, the host device 114 can provide input to and receive output from either of the projector 120, the first sensor 124 or the second sensor 126.

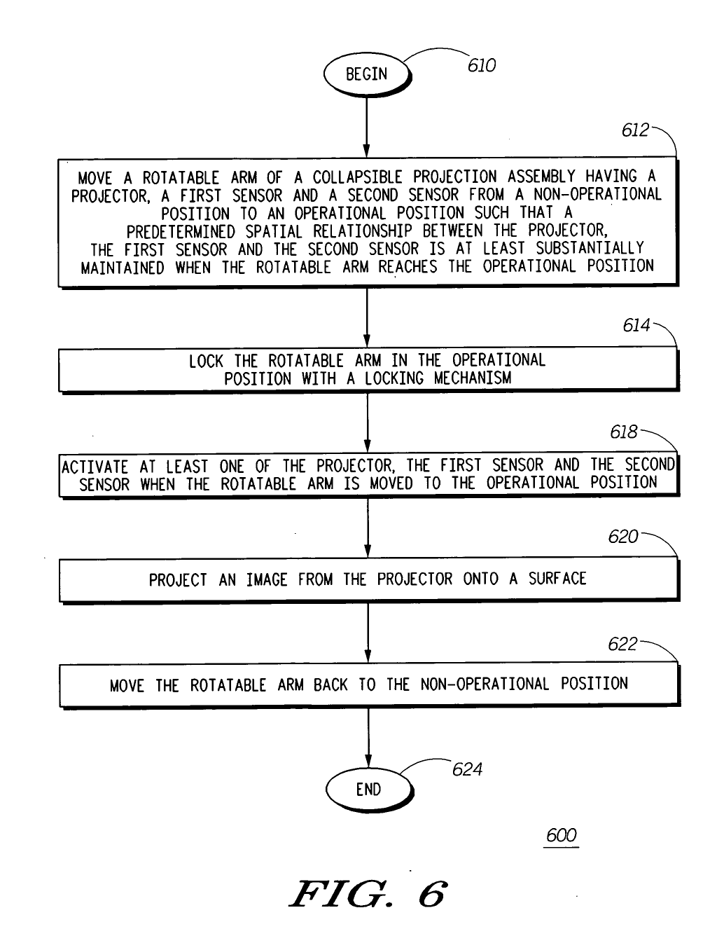

Referring to FIG. 6, a method 600 is shown that can be used to explain the operation of a collapsible projection assembly. To describe the method 600, reference will be made to FIGS. 1-5, although it is understood that the method 600 can be implemented in any other suitable device or system using other suitable components. Moreover, the invention is not limited to the order in which the steps are listed in the method 600. In addition, the method 600 can contain a greater or a fewer number of steps than those shown in FIG. 6.

At step 610, the method 600 can begin. At step 612, the rotatable arm 116 of the assembly 112 can be moved from the non-operational position (see FIG. 2) to the operational position (see FIGS. 1 and 3). The rotatable arm 116 can be moved by a user or, as those of skill in the art will appreciate, by mechanical or electro-mechanical means. When it reaches the operational position, the predetermined spatial relationship, examples of which were described in relation to FIG. 4, can be at least substantially maintained. This process can permit the collapsible projection assembly 112 to operate as a virtual user interface without adding to the storage requirements of, for example, the host device 114.

At step 614, the rotatable arm 116 can be locked in the operational position with the locking mechanism 132. In particular, the protrusion 134 of the rotatable arm 116 can slide along the channel 136 of the locking mechanism 132 until it is forced into the snap fit area 138. This process can keep the rotatable arm 116 stabilized when necessary. In addition, at step 618, at least one of the projector 120, the first sensor 124 and the second sensor 126 can be activated. For example, when the rotatable arm 116 reaches the operational position, the activation mechanism 144 (see FIG. 5) can permit electrical signals to move between the host device 114 and the projector 120, the first sensor 124 and the second sensor 126. It is understood, however, that the activation of these components may occur before the rotatable arm 116 reaches the operational position, if so desired.

At step 620, an image 122 can be projected from the projector 120 onto the surface 110. This image 122 can be any pattern capable of providing user input options, including a QWERTY keyboard, a piano keyboard or a gaming pattern. The user may then use the input device 128 to execute whatever functions he or she desires. At step 622, the rotatable arm 116 can be moved back to the non-operational position (see FIG. 2). For example, a force can be applied to the rotatable arm 116 to cause its protrusion 134 to break out of the snap fit area 138. The protrusion 134 can slide along the channel 136 of the locking mechanism 132, and in response, the rotatable arm 116 can move to the non-operational position. During this process, one or more of the projector 120, the first sensor 124 or the second sensor 126 can be deactivated. The method 600 can then end at step 624.

Where applicable, the present invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A collapsible projection assembly, comprising:
a rotatable arm having at least one pivot point;
a projector that projects an image onto a surface;
a first sensor that detects the location of an input device in relation to the image; and
a second sensor that detects when the input device pierces a plane above the image;
wherein the rotatable arm is movable from a non-operational position to an operational position such that a predetermined spatial relationship between the projector, the first sensor and the second senor is at least substantially maintained when the rotatable arm reaches the operational position.

2. The collapsible projection assembly according to claim 1, further comprising a locking mechanism, wherein the locking mechanism locks the rotatable arm in the operational position and permits the rotatable arm to move to the non-operational position.

3. The collapsible projection assembly according to claim 1, further comprising an activation mechanism, wherein the activation mechanism activates at least one of the projector, the first sensor and the second sensor when the rotatable arm is moved to the operational position.

4. The collapsible projection assembly according to claim 1, wherein the projector, the first sensor and the second sensor are incorporated in the rotatable arm.

5. The collapsible projection assembly according to claim 1, further comprising a base, wherein the pivot point pivotably attaches the rotatable arm to the base.

6. The collapsible projection assembly according to claim 5, wherein the second sensor is incorporated in the base and the first sensor and the projector are incorporated in the rotatable arm.

7. The collapsible projection assembly according to claim 6, wherein the pivot point is located above the second sensor and below the first sensor and the projector.

8. The collapsible projection assembly according to claim 1, wherein the rotatable arm has a protrusion and the locking mechanism includes a channel, wherein the protrusion slides along the channel as the rotatable arm is moved from the non-operational position to the operational position.

9. The collapsible projection assembly according to claim 1, further comprising a flexible circuit that electrically couples the projector, the first sensor and the second sensor.

10. The collapsible projection assembly according to claim 1, wherein the collapsible projection assembly is pivotably coupled to a host device through at least one of the pivot points, wherein the host device provides input to and receives output from at least one of the projector, the first sensor and the second sensor.

11. The collapsible projection assembly according to claim 1, wherein the projector, the first sensor and the second sensor each have a center, wherein the predetermined spatial relationship includes the center of the first sensor being approximately 0.5 millimeters to approximately 2 millimeters in front of the center of the projector and the center of the second sensor being approximately 4 millimeters to approximately 7 millimeters in front of the center of the projector.

12. The collapsible projection assembly according to claim 1, wherein the projector, the first sensor and the second sensor each have a center, wherein the predetermined spatial relationship includes the center of the projector being approximately 70 millimeters to approximately 90 millimeters from the surface, the center of the first sensor being approximately 25 millimeters to approximately 35 millimeters from the surface and the center of the second sensor being approximately 3 millimeters to approximately 6 millimeters from the surface.

13. The collapsible projection assembly according to claim 1, wherein the predetermined spatial relationship includes the projector, the first sensor and the second sensor being positioned at predetermined angles with respect to the surface, the projector being positioned at an angle from approximately 40 degrees to approximately 44 degrees with respect to the surface, the first sensor 124 being positioned at an angle from approximately 10 degrees to approximately 14 degrees with respect to the surface and the second sensor 126 being positioned at angle from approximately 0 degrees to approximately 1.5 degrees with respect to the surface.

14. The collapsible projection assembly according to claim 1, wherein the image is an image of at least one of a QWERTY keyboard, a piano keyboard and a gaming pattern.

15. A collapsible projection assembly, comprising:
a rotatable arm having at least one pivot point;
a locking mechanism, wherein the locking mechanism locks the rotatable arm in an operational position and permits the rotatable arm to move to a non-operational position;
a base, wherein the pivot point pivotably attaches the rotatable arm to the base;
a projector that projects an image onto a surface;
a first sensor that detects the location of an input device in relation to the image; and
a second sensor that detects when the input device pierces a predetermined plane above the image;
wherein the rotatable arm is movable from the non-operational position to the operational position such that a predetermined spatial relationship between the projector, the first sensor and the second senor is at least substantially maintained when the rotatable arm reaches the operational position and wherein the second sensor is incorporated in the base and the first sensor and the projector are incorporated in the rotatable arm.

16. A method of operating a collapsible projection assembly, wherein the collapsible projection assembly has a rotatable arm containing a pivot point and has a projector, a first sensor and a second sensor comprising:
moving the rotatable arm from a non-operational position to an operational position such that a predetermined spatial relationship between the projector, the first sensor and the second senor is at least substantially maintained when the rotatable arm reaches the operational position; and
projecting an image onto a surface from the projector.

17. The method according to claim 16, further comprising activating at least one of the projector, the first sensor and the second sensor when the rotatable arm is moved to the operational position.

18. The method according to claim 16, wherein the collapsible projection assembly further includes a locking mechanism and the method further comprises locking the rotatable arm in the operational position with the locking mechanism.

19. The method according to claim 16, wherein the projector, the first sensor and the second sensor each have a center, wherein the predetermined spatial relationship includes the center of the first sensor being approximately 0.5 millimeters to approximately 2 millimeters in front of the center of the projector and the center of the second sensor being approximately 4 millimeters to approximately 7 millimeters in front of the center of the projector.

20. The method according to claim 16, wherein the projector, the first sensor and the second sensor each have a center, wherein the predetermined spatial relationship includes the center of the projector being approximately 70 millimeters to approximately 90 millimeters from the surface, the center of the first sensor being approximately 25 millimeters to approximately 35 millimeters from the surface and the center of the second sensor being approximately 3 millimeters to approximately 6 millimeters from the surface.

21. The method according to claim 16, wherein the predetermined spatial relationship includes the projector, the first sensor and the second sensor being positioned at predetermined angles with respect to the surface, the projector being positioned at an angle from approximately 40 degrees to approximately 44 degrees with respect to the surface, the first sensor being positioned at an angle from approximately 10 degrees to approximately 14 degrees with respect to the surface and the second sensor 126 being positioned at angle from approximately 0 degrees to approximately 1.5 degrees with respect to the surface.
